(19) United States
(12) Patent Application Publication
(10) Pub. No.: US 2005/0091897 A1
(43) Pub. Date: May 5, 2005

(54) Primary spacer emblematic for secondary emblematics

(76) Inventor: Lonnie L. Lawrence, Odessa, TX (US)

Correspondence Address: Tim Cook;Law Office of Tim Cook P.C., P.O. Box 10107, Liberty, TX, 77575, US

(21) Appl. No.: 10/977,721

(22) Filed: Oct. 29, 2004

Related U.S. Application Data
(60) Provisional application No. 60/515,800, filed on Oct. 29, 2003.

(51) Int. Cl. G09F 3/16

(52) U.S. Cl. 40/666

(57) ABSTRACT

An ornamental device comprising a primary emblematic with a space between the primary emblematic and the surface of an object the primary emblematic is attached to, the space providing a receptacle to releasably hold a second emblematic either frictionally or magnetically, the device combining two completely separate and independent emblems to create a new message.

This application claims the benefit of Provisional U.S. Patent Application Ser. No. 60/515,800 filed Oct. 29, 2003.

### BACKGROUND OF THE INVENTION

1. Field of the Invention

The present invention relates generally to the field of emblematics, and more particularly to the creation of a space or void between a primary emblematic and the surface of an object it attaches to, to accommodate a secondary emblematic sandwiched between the primary emblematic and the object's surface to form a dual emblematic.

2. Description of Prior Art

Various ways to make emblematics have existed for years. As used herein, the term “emblematic” refers to any article of manufacture which displays a company or official logo, school, or event, for example. Distinguishing characteristics of emblematics typically include a fairly small and rigid surface plate providing space for a motif, the plate being typically made out of one or more of a myriad of plastics or metals of sufficient property to render a design thereon intended to display an insignia, logo, crest, or design. Emblematics are commonly used for such items as lapel pins, refrigerator magnet indicia, badges of rank. Emblematics can be attached to key chains, necklaces, bracelets, drinking glasses, cigarette lighters, money clips, belts, belt buckles, cars, or almost any surface intended to display a message or recognizable image. The primary function of the emblematic is to display a message or graphic design via the manufacturing process of casting, stamping, or printing on a rigid material.

The emblematic may or may not have a fastening mechanism to attach to another object; for instance, a coin is an emblematic which typically does not include a mechanism to fasten the coin to another object. For the most part however, emblematics have a fastening mechanism. The fastening mechanism could be any type of pin, hook, clutch, magnet, snap, glue, or similar mechanism. Nevertheless, such mechanism all serve to attach the emblematic. Hence, such fastening mechanisms are not new art and are included in the present disclosure for demonstration purposes and as such, all such methods of fastening are considered included in prior art.

In current or prior art, there are no known emblematics that have the significant advantage of having a primary emblematic with space provided behind the primary emblematic to hold a second emblematic; two wholly separate, complete and independent emblems that when combined form an expanded display revealing new information not contained in the emblematics used separately. Such dual emblematics by addition reveal a new message to the user by combining two emblematics forming larger indicia and a new picture. Thus, in a first aspect, the present invention provides a main or primary emblem with a unique space provided on the back of the emblem to accommodate a second emblematic of different sizes and shapes.

Focusing in more closely to the present disclosure, golf ball markers are one specific instance of a common emblematic. Golf ball markers are used either individually by themselves or as attached to another emblematic or surface such as a fabric. The golf ball marker can attach to a primary emblematic that serves as a holder, as is the case of a divot fixer, or as in the case of a hat bill it can attach to the surface of the fabric. The most common method of attachment of a golf ball marker to a cap's surface is a magnet affixed to the golf ball marker. The magnet then is attracted to a ferrous surface either attached on top of or under the fabric surface. The most common method of attachment of a golf ball marker to another emblematic such as a divot fixer is also a magnet, but usually the magnet is in the primary emblematic, not the golf ball marker.

In the art, no hint or reference has been contemplated of placing a golf ball marker behind another emblematic with a space provided to accommodate such a secondary emblematic. No such primary emblematic exists that can accommodate a secondary emblematic that can slide behind a primary emblematic via a space provided between the primary emblematic and the surface of another object, but rather all present art attaches to the front of an emblematic holding device or surface of an object. Golf ball markers that attach to the front of a primary emblematic hide part of the main emblematic design, thus hiding the main logo of the end user, or, as is the case with all other primary golf ball holder type emblematics such as a divot fixer, they have an unsightly void in the front when the golf ball marker is removed.

In all instances, even if the holder type is decorative under the marker, the front design of the holder is hidden when the ball marker is attached. The present disclosure can also hold many different sizes and shapes of secondary emblematics behind the primary emblematic without compromising the integrity of the piece whereas the holder with a void type cannot. The fastening mechanisms of the above mentioned golf ball markers and emblematic holders are primarily the magnetic type, but the fastening mechanism is not new to the art; the second emblematic sandwiched behind the primary emblematic and the surface of an object is new to the art. The primary emblematics of prior art may have a complete design, but the design on the primary or main emblematic is hidden under the second design of the golf ball marker thus subtracting from the overall message of the primary or main emblem, creating a lesser picture of the primary emblem, not more, and likewise less attractive.

Furthermore, tabs or tassels which can come in the form of ribbon tabs, rocker tabs, and bars, which hang from a primary emblematic such as a lapel pin or the like do create a bigger picture, but are not readily removable to be used as a golf ball marker as the present disclosure affords and do not reside behind the primary emblematic. Such tabs and the like are not stand alone emblematics either. They have unsightly holes or chain links and must be cumbersomely removed from the primary emblematic. Thus, even though the tabs or tassels seemingly address the concept of installing an irregular shaped secondary emblematic beside the primary emblematic to create a bigger picture, the tabs or tassels are not a complete, separate and independent emblematic and are not readily removable and do not reside behind the primary emblematic. The concept of being easily removable is lost and thus cannot be used as a golf ball marker holder as the present disclosure can. The lack of such a feature is commercially unattractive.

The present disclosure combines a secondary emblematic “piggy backed” to the back of a primary emblematic to create a somewhat bigger picture or message, for the secondary emblematic is not completely hidden, thus being partially exposed, is readily removable to be used independently from the primary emblematic.

Furthermore, if the secondary emblematic behind the primary emblematic is lost, the primary emblematic does not become useless, but rather still displays its intended message regardless of the second emblematic. Continuing on in the advantages of the present disclosure, any new object with sufficient characteristics may be substituted into the space between the primary emblematic and surface of an object the primary emblematic is attached to. For instance, the space can accommodate an ordinary coin in so much as the coin is thick enough to fill the space and be frictionally held in place. No such art exists today, not even a golf ball marker and its holder, or tabs and tassels with a primary lapel pin type emblematic. No such current art alludes to such a concept because all current art are a primary emblematic or object surface with an emblematic attached in front of the primary emblematic or object surface. There is no such space as to frictionally hold an object such as a coin and no such primary emblematics with a space for a secondary emblematic between the primary emblematic and the surface of an object the primary emblematic is attached to, and finally there is no such primary emblematic where the secondary emblematic behind the primary emblematic is readily removable to use as a golf ball marker, however, the secondary emblematic does not necessarily have to be used as a golf ball marker. It can be used to simply portray a larger message.

The present invention includes certain criteria, namely, two unconnected, independent, and separate emblematics being readily and releasably combined, never hiding the main emblematic in any way to create a better larger message. Furthermore as previously stated such a concept opens the possibilities for a primary emblematic to hold a coin or favorite lucky token of some type sandwiched between the primary emblematic and the surface of an object the primary emblematic is attached to, or additionally hold any type object that would render itself to be slid into the space, pocket or slot behind the main emblem and the surface of an object the primary emblematic is attached to. Such concept is described in detail in the details section of the present application.

The space, pocket or slot on the back the main or primary emblematic has major cost advantages as well when making emblematics. One primary emblem can be made for one company or school or event accompanied by many secondary emblematics of regular or irregular sizes and shapes which cost much less. The two combined emblematics make up a myriad of different emblematics for one entity. Costs are significantly reduced for the manufacturer and thus for the end user. Secondary emblematics may or may not be used as golf ball markers when combining emblematics may for general purpose be used primarily to display or convey a message, not a golf ball marker. For instance, a school might want the name of the school as the primary emblematic and then use a secondary emblematic, say a football, basketball, or baseball to promote an event or a seasonal sport, all interchangeable depending upon the season or time of event. The primary emblematic can look good all by itself without the secondary emblematics, but addition of the secondary emblematic adds to the specificity of the sport or event at hand. Finally, the secondary emblematic can be all sizes and irregular shapes and, as in the case of the situation when the secondary emblematic is a ball marker, if the ball marker is lost, an alternative object such as a coin or favorite or lucky token can be put in its place. Nothing in present art addresses all the aforementioned advantages and all are primarily for golf ball marker use and with substantially a “round” ball marker.

Many types of emblematics holding a secondary emblematic exist in current art. For example, U.S. Pat. No. 6,422,955 issued to Lopez shows a golf ball marker holding device for use by a golfer that includes a top surface formed from a ferrous material, and having a low rim formed thereon and a rear surface having a pin secured thereto. A resilient, magnetic disk ball marker is held in a cavity defined by the low rim and the top surface, and is easily removed from the cavity to mark the location of a removed golf ball. The pin is secured in an article of clothing, and a butterfly-like clip is secured to the free end of the pin to hold the device to the article of clothing.

U.S. Pat. No. 6,569,039 issued to Cope is a golf ball position marking assembly that includes a marker removably secured to a decorative or functional accessory item such as a ring, pendant, clip, belt, key ring, bracelet, buckle, divot tool, or the like. The marker is magnetically secured to a base in such a way that a golfer can quickly and easily detach it to mark the position of a golf ball, and as easily re-attach it when the time comes to play. The assembly is made of any suitable material, including plastics, metals, ceramics, and composites. If desired, it can include decorative or functional indicia such as precious stones, decorative etching or enameled ornamentation, the user's name or initials, memorable dates, advertising material, tournament logos, or golf club logos.

U.S. Pat. No. 6,170,088 issued to Tate is a ferrous object attached to or embedded within an article of golf clothing so that it is subject to the force of magnetic attraction of a magnet in a ball marker. A magnetic ball marker according to the invention has a body that can be stamped, painted, machined, or otherwise provided with surface embellishments, such as tournament logos, golf course crests, corporate logos, and other visual indicia that are favored by golfers. Unlike conventional golf ball markers, however, a ball marker according to the invention is provided with a thin, flat, permanent magnet that is attached to or embedded within the body of the ball marker. When the ball marker is moved into the proximity of an article of golf clothing modified according to the invention by the incorporation of a ferrous object therein, the ball marker will be attracted to the ferrous object and will cling to the article of golf clothing until purposely removed therefrom. The invention has particular applicability to golf headgear, such a hats and visors. The ferrous objects employed may be configured as thin metal sheets, discs, wafers, or strips attached to or embedded within the bill or a golf hat or visor. The magnet ball marker of the invention is then simply placed in contact with or even in near proximity to the area of the hat at which the ferrous object has been permanently attached. The magnetic ball marker will thereupon cling to the article of golf clothing until removed therefrom for use.

Thus, many different devices exist in prior art for making an emblematic that holds a secondary emblematic, yet none addresses the significant and major advantages of the present disclosure. For example, no primary emblematics in the art allow a secondary emblematic to be sandwiched behind the primary emblematic and in front of the surface of an object the primary emblematic is attached to. This type of process, technique, method of manufacturing or technology has not been developed and has major cost advantages when making emblematics.

### SUMMARY OF THE INVENTION

It is therefore an object of this invention to provide a primary emblematic with a space between the primary emblematic and the surface of an object the primary emblematic is attached to, the space provided to hold a secondary emblematic and frictionally or magnetically grip a secondary emblematic.

It is therefore a further object of this invention to provide a primary emblematic with a space between the primary emblematic and the surface of an object the primary emblematic is attached to, to display multiple events via the space holding any one of a multiple secondary emblematics, with or without the use of a magnet.

It is another object of this invention to provide a primary emblematic with a space between the primary emblematic and the surface of an object the primary emblematic is attached to, the space providing for secondary emblematics with different sizes.

It is therefore an object of this invention to provide a primary emblematic with a space between the primary emblematic and the surface of an object the primary emblematic is attached to, to display multiple events and messages for one entity made of inexpensive material such as plastic.

It is therefore an object of this invention to provide a primary emblematic with a space between the primary emblematic and the surface of an object the primary emblematic is attached to, to provide a primary emblematic that when no secondary emblematic is inserted, still is attractive and complete by itself.

It is therefore an object of this invention to provide a primary emblematic with a space between the primary emblematic and the surface of an object the primary emblematic is attached to, the space providing for a secondary emblematic such as a coin, token or other object.

It is therefore an object of this invention to provide a primary emblematic with a space between the primary emblematic and the surface of an object the primary emblematic is attached to, to provide a primary emblematic that can hold an irregular shaped secondary emblematic.

It is therefore an object of this invention to provide a primary emblematic with a space between the primary emblematic and the surface of an object the primary emblematic is attached to, the space providing for a secondary emblematic a secondary emblematic that is readily removable.

It is therefore an object of this invention to provide a primary emblematic with a space between the primary emblematic and the surface of an object the primary emblematic is attached to, to provide a primary emblematic that can hold an irregular sized and shaped secondary emblematic that is readily removable and interchangeable with other sizes and shapes of secondary emblematics.

It is therefore an object of this invention to provide a primary emblematic with a space between the primary emblematic and the surface of an object the primary emblematic is attached to, the space providing for a secondary emblematic that is much less expensive compared to the primary emblematic.

It is therefore an object of this invention to provide a primary emblematic with a space between the primary emblematic and the surface of an object the primary emblematic is attached to, that is used for advertising.

It is therefore an object of this invention to provide a primary emblematic with a space between the primary emblematic and the surface of an object the primary emblematic is attached to, the space providing for a secondary emblematic that is imprintable on both sides.

### BRIEF DESCRIPTION OF THE DRAWINGS

FIG. 1 is a perspective view of a primary emblematic with a void or space underneath the primary emblematic, a dotted line and arrow indicating the direction and place of insertion of a secondary emblematic with respect to the primary emblematic void or space.

FIG. 2 is a detail view of the back of a primary emblematic with a void or space of a primary emblematic, a dotted line and arrow indicating the direction and place of insertion of a secondary emblematic and revealing a magnet as one preferred method of fastening.

FIG. 3 is a perspective view of the back side of a primary emblematic with a void or space, the secondary emblematic attached to the void or space.

FIG. 4 is a perspective view depicting a primary emblematic with a void or space filled with a secondary emblematic.

FIG. 5 is a perspective view of a primary emblematic turned on its face revealing two spring clips and a magnet.

FIG. 6 is a perspective view showing the primary emblematic attached to an object surface.

### DETAILED DESCRIPTION OF PREFERRED EMBODIMENTS

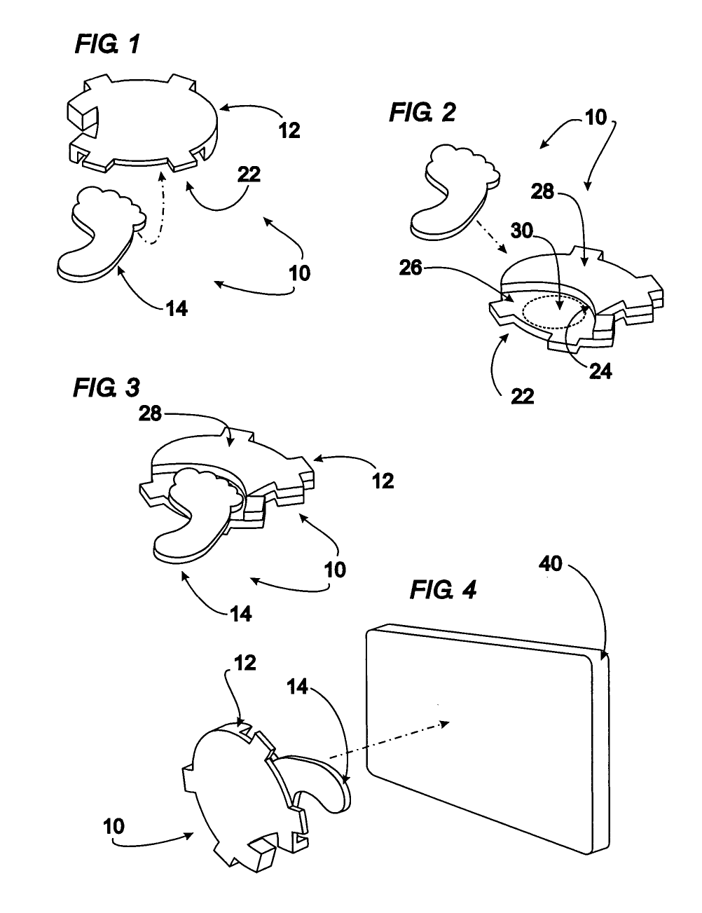

FIGS. 1 through 6 depict a presently preferred embodiment of an ornamental display for combining a primary and secondary emblematic and the resultant device 10 of the present invention. The device 10 comprises a primary ornamental emblematic 12 with a secondary emblematic 14 placed behind the primary emblematic 12 forming a combined ornamental piece, the device 10.

The ornamental display formed by combining a primary and secondary emblematic and the resultant device 10 of the present invention are preferably cast, molded, cut, or stamped units made out of metal or plastic material or blended metal alloys or family of plastics thereof that lend themselves to a stiff but resilient property for stamping, molding, bending and cutting ease. Many other materials could lend themselves to such resiliency properties of casting, molding, bending, stamping and cutting ease and although metal is preferred, the material used should not limit the scope of the invention. For example, the device may be made of flexible metal, flexible alloy, flexible polymer, polyolefins, polyamides, polyethylene, polypropylene, and copolymers and terpolymers thereof, or rubbery polymer.

While the manufacture of the ornamental device 10 by combining a primary emblematic 12 and secondary emblematic 14 and the resultant device 10 of the present invention by a multi-step process of using material of a particular stock, that is subsequently cast, molded, stamped, bent or cut is preferred, it can also be appreciated that the ornamental device 10 by combining a primary emblematic 12 and secondary emblematic 14 and the resultant device 10 of the present invention can also be thermoformed or stamped or a combination thereof, such as is the case with a corrugated carbide fiber plastic or other similar plastic or nylon raw materials and such materials are also well within the scope of the present invention.

The ornamental device 10 by combining a primary emblematic 12 and secondary emblematic 14 and the resultant device 10 of the present invention show a particular embodiment of the device 10 that preferably comprises two substantially flat plate-like three dimensional objects in FIGS. 1-6 with a length, height, and thickness, the primary emblematic 12 having a secondary wall 24 and surface 26 of sufficient depth, length and height to define a space, a void, or a cavity 22 in the primary emblematic 12 where a secondary emblematic 14 may be inserted and held, thus rendering a structure comprising a combination of two emblematics to form a greater picture where combining a primary emblematic 12 and secondary emblematic 14 is additive whereas separated they display two separate yet complete pictures.

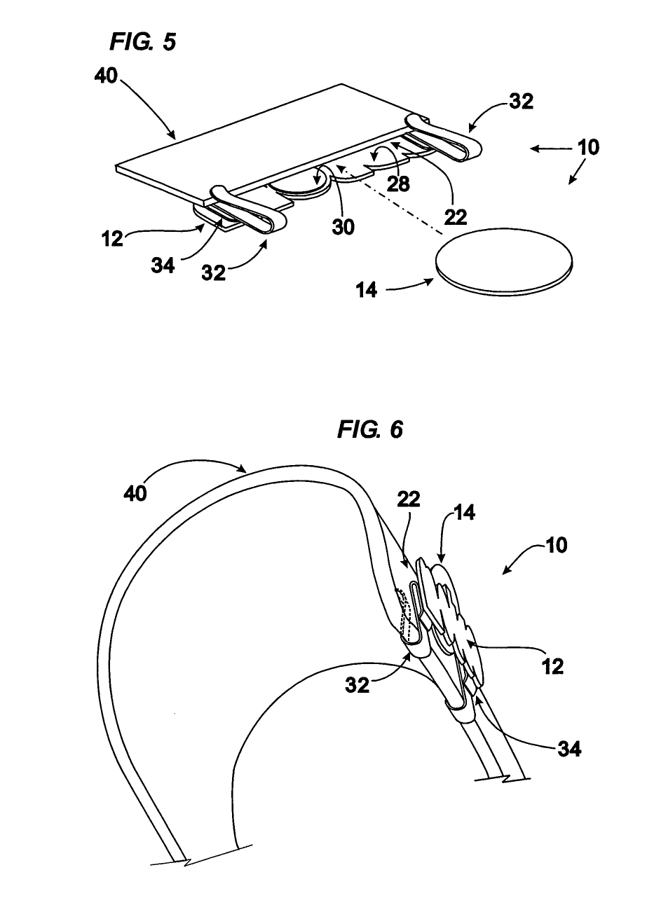

According to this particular preferred embodiment of the invention, the space, void, or cavity 22 allows the insertion of a secondary emblematic 14 and thus the space, void, or cavity 22 is defined by the inner wall 24 and the surface 26 that is formed or hollowed out of roughly less than half a portion of a back side 28 of the primary emblematic 12 in FIGS. 1-6. It consequently forms the surface 26 with a thickness thinner than the thickness of the over-all thickness of the primary emblematic 12. This structure yields the space, void, or cavity 22. In FIGS. 5 and 6, it can be appreciated that such a void can be defined by any type spacer that can lift the back of the primary emblematic 12 far enough away from the surface of an object to allow for the insertion of a secondary emblematic 14 and that such a void may simply be defined by a spacer, in this case two spring clips 32 attached to the back of the primary emblematic with sufficient thickness at 34 on the back of the primary emblematic as to create the space 22 between the primary emblematic and the surface the primary emblematic is attached to, and not a hollowed out void or cavity defined by an inner wall 24 and surface 26 as shown in FIGS. 1-4 that is formed or hollowed out of roughly less than half a portion of the back side 28 of the primary emblematic 12 in FIGS. 1-4. Such a spacer 22 in FIGS. 5-6, whether part of a spring clip 34 or just a raised nodule or bump on the back surface of the primary emblematic should be of sufficient enough thickness to lift the back of the emblem away from the surface of the object 40, or any such spacer method as would lift the back of the primary emblematic 12 away from the surface of the object 40, and such types of spacer should not limit the scope of the present invention.

The width, height and depth of the void or cavity 22 in FIGS. 1-6 with a fastening mechanism 30, in this case, a small round magnet, is large enough to insert and hold the secondary emblematic 14 in place against a reasonable jolt or force as might be experienced during any particular use by the user, yet readily releasable enough to permit the constant removal and reinsertion of the ornamental secondary emblematic 14 from and back onto the fastening mechanism 30 as needed. The size of the void or cavity 22, defined by an inner wall 24 and surface 26 in FIGS. 1-4 may be such that “one size fits all” so as to accommodate irregular shaped as well as substantially rounded secondary emblematics 14, and such inner wall 24 may not exist at all and surface 26 would then be surface 28 the back of the emblematic 12 with no wall defining a void, rather any type spacer 34 of spring clips 32 or any other type of spacers would lift the back of the emblematic 12 far enough away from the surface of the object 40 as to allow for insertion of a secondary emblematic 14.

Considering the many different variables of cuts and shapes of secondary emblematics 14 and the many different types of fastening mechanisms available, the ornamental fastening mechanism 30 in FIGS. 1-6 are conveniently shown as a round thin magnet fastening mechanism inset onto surface 26, and is only one preferred embodiment of many different types of fastening mechanisms capable of gripping the secondary emblematic 14 surface including frictional nodules, spring clips, and Velcro® inside the void 22 and can work in conjunction with a magnet as well. The ornamental primary emblematic 12 of FIGS. 1-6 provide for attachment of many different styles and shapes of secondary emblematics 14, here shown as a small foot print. Considering the scope of the invention, many designs are capable of attaching to the primary emblematic 12 and become part of the function of the ornamental device 10 forming a combined picture or display such as having a primary emblematic 12 displaying a name of a school while the secondary emblematic 14 displays a football, or a number, or a figurine and thus forming a combined picture greater than the pieces individually could display.

A preferred embodiment of the ornamental device 10 is to mount the ornamental device 10 onto a baseball cap type visor shown as a flat surface object 40 of FIGS. 4-5 and in more detail in FIG. 6, but just as well could be an article of clothing or any other myriad of surfaces that would yield favorably to the usefulness of the invention disclosed. By attaching to the ornamental device 10 to a baseball cap type visor surface 40, shown in FIGS. 4-6, the user can readily remove and interchange the secondary emblematic 14 with other secondary emblematics 14 by grasping with a finger and slipping the secondary emblematic 14 out of the primary emblematic 12 and thus change the display into a new and different display without removing the primary emblematic 12 from the surface object 40. The secondary emblematic 14 is so lodged between the surface of the object 40 and the primary emblematic that the secondary emblematic 14 is readily removable and interchangeable.

Although the ornamental device 10 in FIGS. 1-4 is shown as having an inner wall 24 and surface 26 as being primarily a void or cavity 22 shaped like a half moon, the inner wall 24 and surface 26 may be other shapes and have other fastening mechanisms 30, yet have similar function as the present disclosure, and should not limit in scope the disclosed significant advantages of the invention.

The ornamental device 10 with primary emblematic 12 and secondary emblematic 14 can be packaged for resale as a single unit, or, the primary emblematic 12 and secondary emblematic 14 individually. They can then be shipped as either as a combined unit or as components to the retail outlets as a finished product or distributors as a promotional product.

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

1. A device comprising a primary ornamental emblematic with a space between the primary emblematic and a surface of an object the primary emblematic is adapted to be attached to, the space comprising a means to retain at least one secondary ornamental emblematic.

2. The device of claim 1, further comprising a fastening mechanism joined to the primary ornamental emblematic to releasably attach to the surface of the object.

3. The device of claim 1, further comprising a fastening mechanism joined to the primary ornamental emblematic to permanently attach to the surface of the object.

4. The device of claim 1, wherein the primary ornamental emblematic has at least one fastening mechanism to releasably attach a second emblematic.

5. The device of claim 1, wherein the primary ornamental emblematic is formed of a material selected from the group consisting of ferrous metals, non-ferrous metals, and metal alloys.

6. The device of claim 1, wherein the primary ornamental emblematic is formed of a material selected from the group consisting of polymers, polyolefins, polyamides, polyethylenes, polypropylenes, and copolymers and terpolymers thereof, and rubbery polymers.

7. The device of claim 1, wherein the secondary ornamental emblematic is formed of a material selected from the group consisting of ferrous metals, non-ferrous metals, and metal alloys.

8. The device of claim 1, wherein the secondary ornamental emblematic is formed of a material selected from the group consisting of polymers, polyolefins, polyamides, polyethylenes, polypropylenes, and copolymers and terpolymers thereof, and rubbery polymers.

9. The device of claim 1, wherein the primary emblematic is held in place and spaced substantially far enough away from the surface of an object by at least one spring clip to allow a secondary emblematic to be placed into a space between the primary emblematic and the surface of the object the primary emblematic is attached to.

10. The device of claim 1, further comprising a fastening mechanism on the back of the primary emblematic having a surface sufficiently close enough to the surface of an object that the space will frictionally hold a secondary emblematic between the primary emblematic and the surface of an object the primary emblematic is attached to.

11. The device of claim 1, wherein the secondary emblematic is frictionally held between the primary emblematic and the surface of an object the primary emblematic is attached to.

12. The device of claim 1, wherein the primary ornamental emblematic has at least one fastening mechanism to hold the secondary emblematic that is attached to the back of primary emblematic and selected from the group consisting of a magnet, Velcro®, and a spring clip.

13. The device of claim 1, wherein a secondary emblematic when attached to the primary emblematic is substantially exposed as to easily be removed.

14. The device of claim 1, wherein the primary ornamental emblematic comprises at least one space between the primary emblematic and the surface of an object the primary ornamental emblematic attaches to, the space comprising a means to releasably attach at least one secondary emblematic.

15. The device of claim 1, further comprising a fastening mechanism joined to the primary emblematic defining at least one hidden hollowed out coin slot type cavity adapted to receive a secondary emblematic.

16. The device of claim 1, wherein the secondary emblematic is a ferrous material without a magnet.

17. The device of claim 1, wherein the secondary emblematic is a non-ferrous material without a magnet.

18. The device of claim 1, wherein the secondary emblematic is a golf ball marker.

19. The device of claim 1, wherein the primary and secondary emblematic together define a plate.

20. The device of claim 1, wherein each of the primary and secondary emblematic is irregularly shaped.

21. The device of claim 1, wherein at least one cavity and the primary emblematic comprise one molded unit.

22. The device of claim 1, wherein the primary emblematic and secondary emblematic together reveal an expanded message not contained in the primary emblematic alone.

23. The device of claim 1, wherein the primary emblematic and secondary emblematic together define an advertisement.

24. The device of claim 1, wherein the primary emblematic is independent of the secondary emblematic and conveys a complete message without the use of a secondary emblematic.

25. The device of claim 1, wherein the secondary emblematic coveys a complete message not contained in the primary emblematic alone.

26. The device of claim 1, wherein the secondary emblematic has no fastening mechanism attached.

27. The device of claim 1, wherein the secondary emblematic is imprintable on both sides.

28. The device of claim 1, wherein the secondary emblematic is a coin.

29. The device of claim 1, further comprising a fastening mechanism molded with the primary emblematic.

30. The device of claim 1, wherein the secondary emblematic is a three dimensional object.
